(19) United States
(12) Patent Application Publication
(10) Pub. No.: US 2010/0309060 A1
(43) Pub. Date: Dec. 9, 2010

(54) ANTENNA DEVICE AND WIRELESS COMMUNICATION EQUIPMENT USING THE SAME

(76) Inventor: Yasumasa Harihara, Tokyo (JP)

Correspondence Address: MCDERMOTT WILL & EMERY LLP, 600 13TH STREET, N.W., WASHINGTON, DC, 20005-3096, US

(21) Appl. No.: 12/739,859

(22) PCT Filed: Oct. 23, 2008
(86) PCT No.: PCT/JP2008/069198

§ 371 Date: Aug. 16, 2010

(30) Foreign Application Priority Data
Oct. 26, 2007 (JP) 2007-279418

(51) Int. Cl. H01Q 1/38

(52) U.S. Cl. 343/700 MS

(57) ABSTRACT

An object of the present invention is to provide a compact, high-performance antenna device in which a decrease in production yield caused by a production variation can be prevented. An antenna device 100 of the present invention is a direct feed type of λ/4 inverted F antenna, and the antenna device 100 includes an antenna block 10 and a mounting board 20 on which the antenna block 10 is mounted. First and second pad electrodes 13 and 14, a side surface conductor 17, and an upper surface conductor 12, which are formed on a base 11 of the antenna block 10, constitute one continuous radiation conductor. A gap 18 is provided in the second side surface conductor 17, and a trench is formed in a surface of the base 11 in a position where the gap 18 is formed. An impedance adjusting pattern 27 that is of a ground electrode is provided between a first land 23 and a ground pattern 22. That is, the production variation can be prevented because the antenna device 100 has a structure in which the antenna block does not include the ground electrode.

### TECHNICAL FIELD

The present invention relates to an antenna device, particularly to a conductive pattern structure of a surface-mounted antenna that is incorporated in a cellular phone and suitably used as an antenna for Bluetooth or GPS. The present invention is also relates to a wireless communication equipment using the antenna device.

### BACKGROUND OF THE INVENTION

An inverted F antenna, in which miniaturization can be achieved and impedance matching is easily performed, is preferably used as a chip antenna incorporated in a mobile terminal such as a cellular phone (for example, see FIGS. 9 and 10 of Japanese Patent Publication Laid-open No. 2003-46322). For example, as shown in FIG. 12, in a configuration of the inverted F antenna, usually a feed electrode 9 and a ground electrode 3 are provided in one of surfaces of a dielectric block 2.

A chip antenna mounting mode is roughly divided into a ground clearance type and an on-ground type. The ground clearance type chip antenna is mounted in a ground clearance region. The ground clearance region is larger than the chip antenna, and is formed by partially removing a ground pattern on a mounting board. In the ground clearance type, the ground clearance region is secured in not only an antenna mounting surface but also a back side or under layer region. In the on-ground type, an antenna use region substantially equal to the chip antenna is provided only in the mounting surface.

For the ground clearance type, because a ground surface does not exist below the chip antenna, the chip antenna has a low profile. However, it is a problem that a board area is widely occupied. On the other hand, for the on-ground type, because the ground pattern is provided in the mounting surface and the lower region, the profile of on-ground type is higher than the ground clearance type. However, a surface of a multilayer board is used as the antenna mounting surface, and the mounting surface and an inner layer are used as the ground pattern layer, which allows the back side of the board to be used as a component mounting region to achieve the substantial miniaturization of the antenna.

There are a direct feed method and a gap feed method in a chip antenna feeding method (for example, see Japanese Patent Publication Laid-open No. 2003-46322). When the gap feed method is adopted in mounting the on-ground type antenna, a coupling capacitance largely changes according to a difference between a position of the antenna on the mounting board and a position of the ground pattern, and antenna characteristics largely change. Therefore, the direct feed method is preferably adopted in mounting the on-ground type antenna.

There is also well known a chip antenna having a structure in which a radial electrode is folded in order to obtain a desired resonant frequency in a restricted volume that is extremely smaller than λ/4 in a free space (for example, see Japanese Patent Publication Laid-open No. 2003-46314).

As described above, the conventional inverted F antenna has the structure in which the feed electrode and the ground electrode are provided in one of the surfaces of the dielectric block. However, because the electrode patterns are formed by screen printing using a conductive paste, there is a problem that a variation is generated in the antenna resonant frequency or impedance matching by a printing variation. For the structure in which the radial electrode is folded in order to secure the antenna length, because orientations of currents cancel each other, efficiency is degraded. Additionally the complicated structure causes the variation in resonant frequency in mass production, which results in a problem of a decrease in production yield.

The resonant frequency or impedance of the chip antenna changes by influences of a mounting board structure, various electronic components mounted in the surroundings, and a chassis. Therefore, it is necessary to adjust the impedance or resonant frequency of the antenna in each model. In the conventional chip antenna, it is necessary to adjust the antenna conductive pattern in each model.

### SUMMARY OF THE INVENTION

In view of the foregoing, an object of the present invention is to provide a compact, high-performance antenna device in which the decrease in production yield caused by the production variation can be prevented.

Another object of the present invention is to provide a compact, high-performance wireless communication equipment in which the antenna device of the present invention is used.

To solve the above problems, an antenna device according to the present invention includes an antenna block and a mounting board on which the antenna block is mounted, wherein the antenna block includes: a base that is made of a dielectric material or a magnetic material and has substantially rectangular parallelepiped shape; an upper surface conductor that is formed on an upper surface of the base; first and second pad electrodes that are formed in end portions in a longitudinal direction of a bottom surface of the base; a first side surface conductor that is formed on a first side surface of the base to directly connect the upper surface conductor and the first pad electrode; and a second side surface conductor that is formed on a second side surface of the base and includes a gap having a predetermined width, the second side surface conductor connecting the upper surface conductor and the second pad electrode through the gap, and the mounting board includes: an antenna block mounting region that is provided in one of principal surfaces; first and second land patterns that are provided in the mounting region corresponding to positions of the first and second pad electrodes, respectively; a first ground pattern that is provided around the mounting region; a feed line that is connected to the first land pattern; and a first impedance adjusting unit that connects the first land pattern and the first ground pattern.

In the structure of the antenna device in accordance with the invention, the first impedance adjusting unit provided on the mounting board acts as the ground electrode of the inverted F antenna, and the antenna block does not have the ground electrode, so that the variation in antenna characteristic caused by a position deviation of the ground electrode can be prevented. The gap is provided in the leading end portion of the radial electrode to adjust the capacitance of the radial electrode, so that the resonant frequency can be decreased. Accordingly, the radial electrode can be formed by a linear pattern with no folded structure, and the compact, high-efficiency antenna can be realized.

In the present invention, it is preferable that the mounting board further includes a second ground pattern that is provided below the mounting region. The antenna device in accordance with the present invention is the on-ground type and the board area is not excessively occupied. Therefore, effective utilization of the board area can be achieved and the substantial miniaturization of the antenna device can be achieved.

Preferably the antenna device of the present invention further includes a second impedance adjusting unit that connects the feed line and the first ground pattern. Accordingly, the impedance can finely be adjusted when the antenna block is mounted on the mounting board. Additionally the resonant frequency can be adjusted without changing the antenna structure.

Preferably the antenna device of the present invention further includes a first frequency adjusting unit that connects the second land pattern and the first ground pattern. Accordingly, the resonant frequency can be adjusted without changing the antenna structure.

In the present invention, it is preferable that the antenna block further includes a third pad electrode that is formed in a central portion in a longitudinal direction of the bottom surface of the base, and the mounting board further includes a third land pattern that is provided in the mounting region corresponding to the position of the third pad electrode. At this point, it is preferable that the antenna device of the present invention further includes a second frequency adjusting unit that is provided on the mounting board to connect the third land pattern and the first ground pattern. Accordingly, the resonant frequency can finely be adjusted when the antenna block is mounted on the mounting board.

In the antenna device of the present invention, it is preferable that a trench is provided in a position where the gap is formed on the second side surface of the base. Accordingly, the gap can be formed with extremely high accuracy. Further, it is preferable that a sectional shape of the trench is a substantially U-shape. When the sectional shape of the trench is the substantially U-shape, because a crack is not generated from the origin of a corner potion, strength of the base 11 can be enhanced.

In the present invention, it is preferable that the first side surface conductor has a constriction whose width is narrower than that of the base. Accordingly, the first side surface conductor can be formed as a substantially I-shape or substantially T-shape conductive pattern, and a variation in permittivity generated among material lots of the base can be absorbed to keep the antenna characteristic constant.

In the antenna device of the present invention, it is preferable that a hole is formed on third and fourth side surfaces of the base, the third and fourth side surfaces being different from the first and second side surfaces. The hole may be a through-hole, or does not pierce through the base. When the hole is made in the third and fourth side surfaces of the base, weight saving of the base, that is, the weight saving of the whole antenna device can be achieved.

In the present invention, it is preferable that the upper surface conductor includes: a first upper surface conductor that is provided in the center of a width direction of the upper surface of the base ; and a second upper surface conductor that is provided in parallel with the first upper surface conductor on at least one side of the first upper surface conductor, and one end of the first upper surface conductor is connected to one end of the second upper surface conductor through the second side surface conductor, and the other end of the second upper surface conductor is opened. At this point, it is particularly preferable that the upper surface conductor includes: the first upper surface conductor that is provided in the center of the width direction of the upper surface of the base; and second and third upper surface conductors that are provided in parallel with the first upper surface conductor on both sides of the first upper surface conductor, and one end of the first upper surface conductor is connected to one end of each of the second and third upper surface conductors through the second side surface conductor, and the other end of each of the second and third upper surface conductors is opened.

According to this structure, because the radiation conductor formed on the upper surface of the base has the folded structure, a desired electric length can be secured even if the base is miniaturized, the antenna having the low resonant frequency can be realized, and a good radiation characteristic can be obtained. The second side surface conductor having the gap is interposed in the folded position between the first upper surface conductor and the second and third upper surface conductors, so that the stable antenna characteristic can be obtained irrespective of the position on the mounting board. The symmetrical pattern layout can be obtained when the second and third upper surface conductors are provided on both sides of the first upper surface conductor. Accordingly, the antenna design can be facilitated to reduce mounting constraints.

The object of the present invention is also achieved by a wireless communication equipment including the antenna device according to the present invention.

Thus, the invention can provide the compact, high-performance antenna device in which the decrease in production yield caused by the production variation can be prevented.

Further, the invention can provide the compact, high-performance wireless communication equipment in which the antenna device of the present invention is used.

### BRIEF DISCRIPTION OF THE DRAWINGS

FIG. 1 is a schematic perspective view showing a configuration of an antenna device according to a first embodiment of the present invention;

FIG. 2 is a development diagram of the antenna block of FIG. 1;

FIG. 3 is a schematic perspective view showing a structure near the gap 18;

FIG. 4 is a schematic sectional view showing another example of the shape of the gap 18;

FIGS. 5A and 5B are schematic plan views showing a configuration of the mounting board 20;

FIG. 6 is a graph showing comparison a characteristic of the antenna device 100 of the first embodiment and a characteristic of the conventional antenna device (see FIG. 8);

FIG. 7 is a development diagram showing a configuration of an antenna block 50 of an antenna device 200 according to a second embodiment of the present invention;

FIG. 8 is a schematic perspective view showing a configuration of an antenna block according to a third embodiment of the present invention;

FIG. 9 is a development diagram of the antenna device of FIG. 8;

FIG. 10 is a development diagram showing a modification of the antenna block 10;

FIG. 11 is a development diagram showing a modification of the antenna block 10; and

FIG. 12 is a schematic perspective view showing a general configuration of a conventional antenna device.

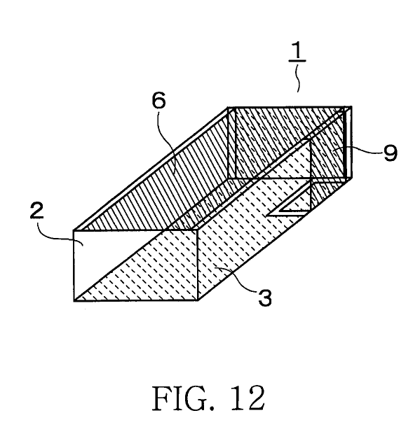

### DETAILED DESCRIPTION OF THE EMBODIMENTS

Preferred embodiments of the present invention will be described in detail hereinafter with reference to the accompanying drawings.

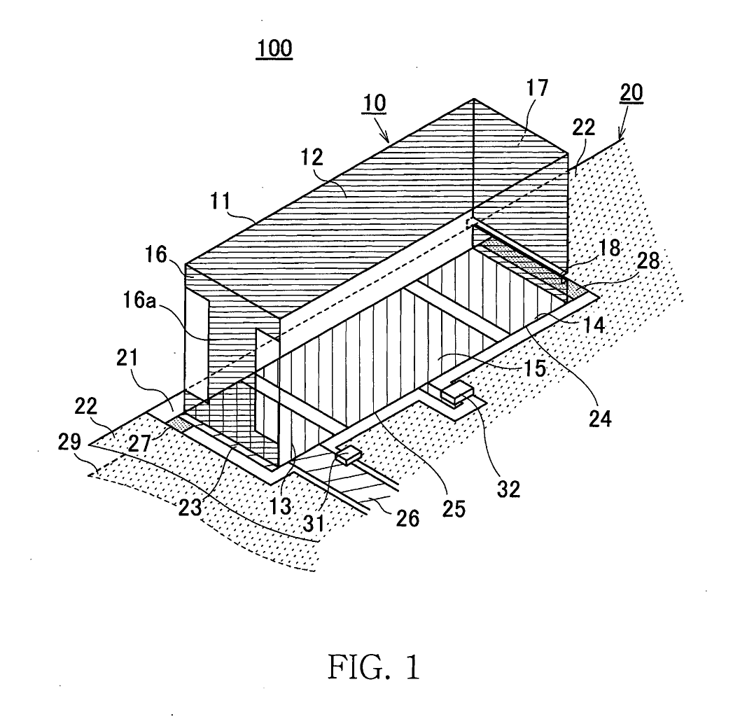

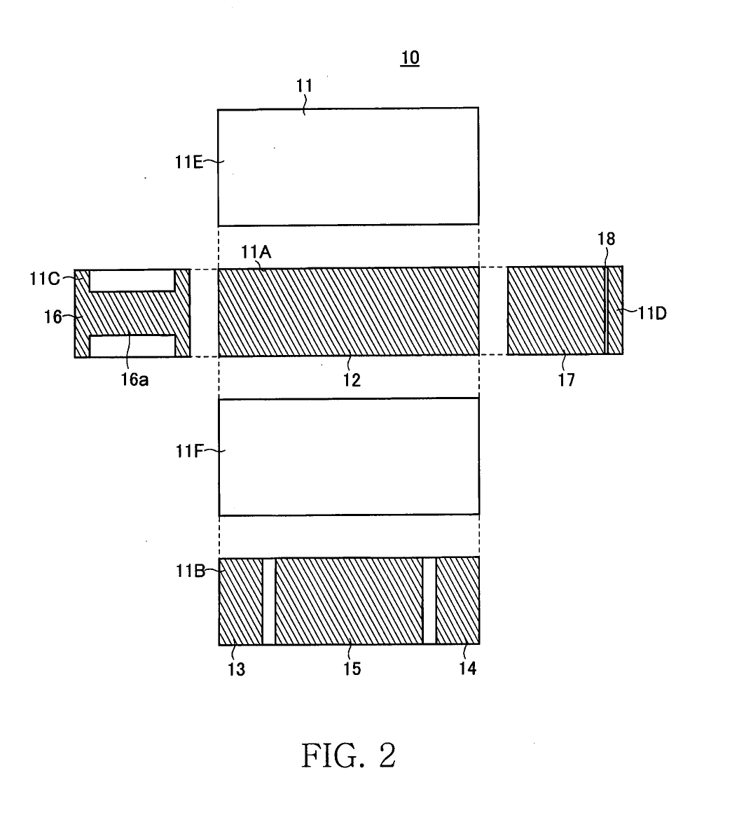

FIG. 1 is a schematic perspective view showing a configuration of an antenna device according to a first embodiment of the present invention. FIG. 2 is a development diagram of the antenna block of FIG. 1.

As shown in FIG. 1, an antenna device 100 of the first embodiment includes an antenna block 10 and a mounting board 20 on which the antenna block 10 is mounted.

As shown in FIG. 2, the antenna block 10 includes a base 11 that is made of a rectangular parallelepiped dielectric material, an upper surface conductor 12 that is formed on an upper surface 11A of the base 11, first to third pad electrodes 13 to 15 that are formed on a bottom surface 11B of the base 11, a first side surface conductor 16 that is formed on a first side surface 11C orthogonal to a longitudinal direction of the base 11, and a second side surface conductor 17 that is formed on a second side surface 11D opposite the first side surface 11C. The conductive pattern is not formed in third and fourth side surfaces 11E and 11F parallel to the longitudinal direction of the base 11.

A size of the base 11 may appropriately be set in accordance with an intended antenna characteristic. It is not particularly limited, but the size of the base 11 is set to 10×2×4 (mm) in this embodiment.

Examples of a material for the base 11 include, but are not limited to, Ba—Nd—Ti materials (relative permittivity of 80 to 120), Nd—Al—Ca—Ti materials (relative permittivity of 43 to 46), Li—Al—Sr—Ti materials (relative permittivity of 38 to 41), Ba—Ti materials (relative permittivity of 34 to 36), Ba—Mg—W materials (relative permittivity of 20 to 22), Mg—Ca—Ti materials (relative permittivity of 19 to 21), sapphire (relative permittivity of 9 to 10), alumina ceramics (relative permittivity of 9 to 10), and cordierite ceramics (relative permittivity of 4 to 6). These materials are burned with a metallic mold to produce the base 11.

The dielectric material may appropriately be selected in accordance with the target frequency. A length of a radiation conductor can be shortened because a wavelength shortening effect is increased with increasing relative permittivity εᵣ. However, it is not always necessary to increase the relative permittivity εᵣ, but a proper value of the relative permittivity εᵣ exists. For example, a material having the relative permittivity εᵣ of about 5 to 30 is preferably used when the target frequency is 2.40 GHz. Therefore, the compact radiation conductor can be achieved while a sufficient gain is secured. Mg—Ca—Ti dielectric ceramics can be cited as an example of the material having the relative permittivity εᵣof about 5 to 30. As a material having a relative permittivity εᵣ of about 5 to 30, it is particularly preferable to use the Mg—Ca—Ti dielectric ceramics containing TiO₂, MgO, CaO, MnO, and SiO₂.

The upper surface conductor 12 is a conductive pattern that is formed on the substantially whole upper surface 11A of the base 11. One end in the longitudinal direction of the upper surface conductor 12 is connected to the first pad electrode 13 through the first side surface conductor 16. The other end in the longitudinal direction of the upper surface conductor 12 is connected to the second pad electrode 14 through the second side surface conductor 17. Therefore, the first and second pad electrodes 13 and 14, the first and second side surface conductors 16 and 17, and the upper surface conductor 12 constitute the continuous radiation conductor having a substantially linear shape. Because the radiation conductor is formed over the plural surfaces of the base 11, the desired electric length can be secured even if the base 11 is miniaturized.

The first and second pad electrodes 13 and 14 are rectangular conductive patterns that are formed at both ends in the longitudinal direction of the bottom surface 11B of the base 11, respectively. The third pad electrode 15 is a conductive pattern that is formed in a central portion in the longitudinal direction of the bottom surface 11B of the base 11, and is formed between the first pad electrode 13 and the second pad electrode 14. Preferably the sizes of the first and second pad electrodes 13 and 14 are equal to each other, and preferably the first to third pad electrodes 13 to 15 are symmetrically formed such that the first to third pad electrodes 13 to 15 have the same shapes when being rotated by 180 degrees in relation to an axis (Z-axis) perpendicular to the upper and lower surfaces 11A and 11B of the base 11. Therefore, the layout design of the mounting board can be facilitated and the stabilization and reliability of the antenna characteristic can be improved.

The first side surface conductor 16 is a substantially I-shape conductive pattern that is formed on the first side surface 11C of the base 11. That is, the first side surface conductor 16 includes a constriction 16a whose width is narrower than that of the first side surface 11C. Preferably the width of the constriction 16a of the first side surface conductor 16 is set to, but not be limited to, about 1 mm when the base 11 has the width of 2 mm. An antenna resonant frequency is decreased with narrowing width of the radiation conductor, and an influence of the width of the radiation conductor on the resonant frequency is increased as the width of the radiation conductor comes close to a feed point. Therefore, the first side surface conductor 16 is formed as the I-shape conductive pattern to adjust the width of the constriction 16a, which allows a variation in permittivity generated among production lots of the base bodies 11 to be absorbed to keep the antenna resonant frequency constant.

The second side surface conductor 17 is a conductive pattern that is formed on the substantially whole second side surface 11D of the base 11 except a region where a gap 18 is formed. The gap 18 is provided close to the bottom surface, that is, in a leading end portion farthest away from the feed point. The leading end portion of the radiation conductor is sensitive to the antenna frequency, and the gap is formed in the leading end portion of the radiation conductor. Therefore, not only the antenna resonant frequency can be decreased, but also accuracy of the resonant frequency is enhanced.

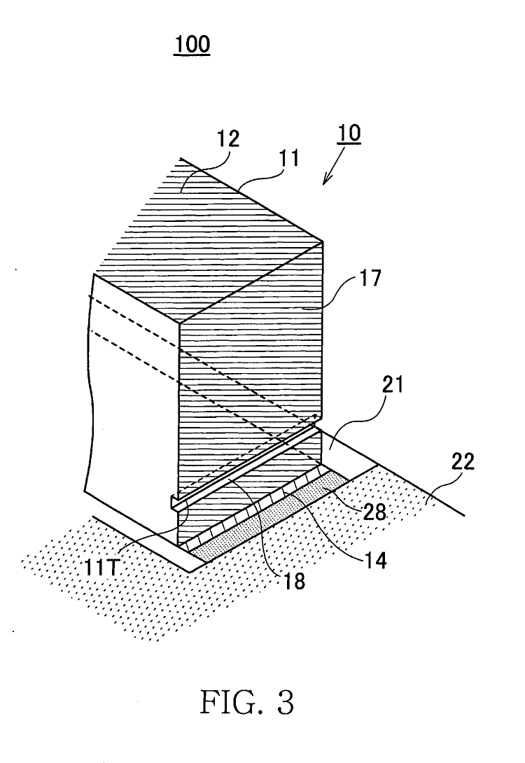

FIG. 3 is a schematic perspective view showing a structure near the gap 18.

As shown in FIG. 3, a trench 11T is preferably formed in the surface of the base 11 in the position where the gap 18 is formed. The trench 11T is molded at the same time as the base 11 is molded using a metallic mold. Usually the conductive pattern in the surface of the base 11 is formed by screen printing, and the screen printing has the accuracy of about 50 μm that is not so high. Therefore, the width or shape of the gap 18 changes due to printing misalignment to easily generate the variation in antenna characteristic. On the other hand, working accuracy of the trench 11T with the metallic mold is as extremely high as about 5 μm. The variation in trench shape due to the variation in shrinkage ratio of the burned material is also extremely smaller than the printing misalignment. Accordingly, when the screen printing is performed to the side surface of the base 11 in which the trench 11T is formed, not only the gap 18 is inevitably formed by the existence of the trench 11T, but also the gap width can correctly be defined.

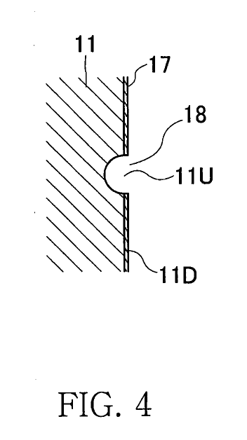

FIG. 4 is a schematic sectional view showing another example of the shape of the gap 18.

As shown in FIG. 4, a trench 11U is formed in the second side surface 11D of the base 11 in the position where the gap 18 is formed. Unlike the trench 11T of FIG. 3 having the corner portion, the trench 11U has the feature that the trench 11U is formed by a curved surface with no corner portion. That is, the sectional shape of the trench 11U is a substantially U-shape. When the trench 11U has the curved surface, a crack is not generated from an origin of the corner portion, so that strength of the base 11 can be enhanced.

It is preferable that each of the conductive patterns formed on the surfaces of the base 11 is symmetrically formed in relation to a plane parallel to the third and fourth side surfaces 11E and 11F of the base 11. At this point, even if the orientation of the antenna block is rotated by 180 degrees based on the Z-axis, the shape of the conductive pattern of the antenna block becomes substantially identical when viewed from an end portion side of the mounting board 20, so that the antenna characteristic does not change largely according to the orientation of the mounting, thus the antenna design can be facilitated.

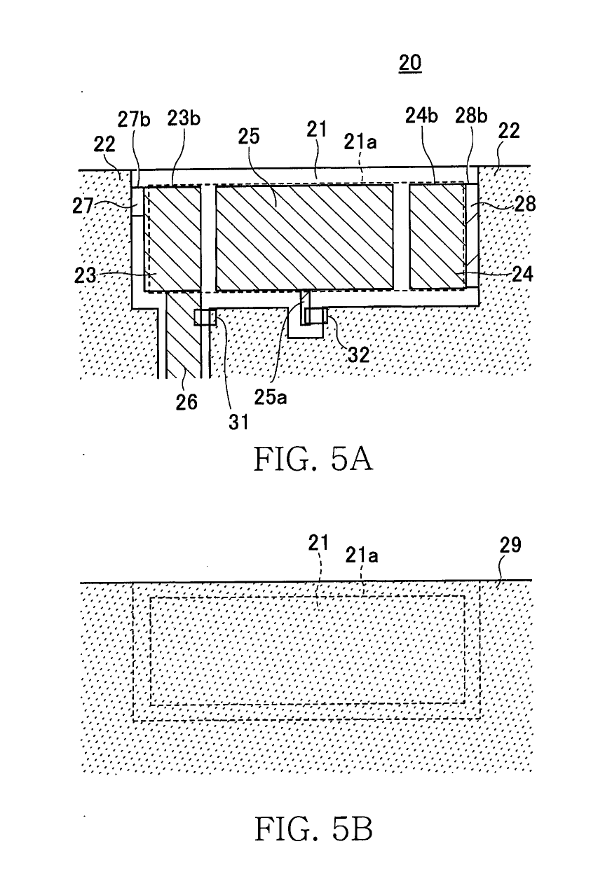

FIGS. 5A and 5B are schematic plan views showing a configuration of the mounting board 20.

As shown in FIGS. 5A and 1, the mounting board 20 includes a ground clearance region 21 where a ground pattern is not provided, a ground pattern 22 that is provided around the ground clearance region 21, first to third lands 23 to 25 that are provided in the ground clearance region 21, and a feed line 26 that is connected to the first land 23. The mounting board 20 also includes an impedance adjusting pattern 27 that connects the first land 23 to the ground pattern 22 and a frequency adjusting pattern 28 that connects the second land 24 to the ground pattern 22. A mounting region (antenna mounting region) 21a of the antenna block 10 is indicated by a broken line. Although not illustrated, various electronic components are mounted on the mounting board 20 in order to constitute the wireless communication equipment.

The ground clearance region 21 is provided along the end portion of the mounting board 20. Therefore, while three directions around the ground clearance region 21 are surrounded by the ground pattern 22, the remaining one direction is an open space in which the board does not exist. The ground pattern 22 is formed only in the surface of the mounting board 20. As shown in FIG. 5B, a ground pattern 29 is provided in a back side or an inner layer of the mounting board 20, and the ground pattern 29 also exists immediately below an antenna mounting region 21a. That is, the mounting board 20 of this embodiment is the on-ground type.

The first land 23 in the ground clearance region 21 corresponds to the first pad electrode 13 of the antenna block 10, the second land 24 corresponds to the second pad electrode 14, and the third land 25 corresponds to the third pad electrode 15. Accordingly, when the antenna block 10 is mounted on the mounting board 20, the first pad electrode 13 is soldered to the first land 23, the second pad electrode 14 is soldered to the second land 24, and the third pad electrode 15 is soldered to the third land 25.

The conductive pattern (impedance adjusting pattern) 27 that is of the first impedance adjusting unit is provided between the first land 23 and the ground pattern 22. The impedance adjusting pattern 27 of the first embodiment is a rectangular conductive pattern, and a side 27b of the impedance adjusting pattern 27 located on the end portion side of the board and a side 23b of the first land 23 located on the end portion side of the board are located on the same straight line. The antenna impedance can be adjusted by changing the width of the impedance adjusting pattern 27.

The conductive pattern (frequency adjusting pattern) 28 that is of the first frequency adjusting unit is provided between the second land 24 and the ground pattern 22. The frequency adjusting pattern 28 of the first embodiment is a rectangular conductive pattern, and a side 28b of the frequency adjusting pattern 28 located on the end portion side of the board and a side 24b of the second land 24 located on the end portion side of the board are located on the same straight line. The antenna resonant frequency can be adjusted by changing the width of the frequency adjusting pattern 28.

The feed line 26 is connected to the first land 23, and a chip reactor 31 that is of the second impedance adjusting unit is mounted between the feed line 26 and the ground pattern 22. The chip reactor 31 is preferably mounted outside the ground clearance region 21 and close to the ground clearance region 21 as much as possible.

A chip reactor 32 that is the second frequency adjusting unit is mounted between the third land 25 and the ground pattern 22. The chip reactor 32 is inserted in series between the ground pattern 22 and a lead portion 25a of the third land 25. The chip reactor 32 is preferably mounted outside the ground clearance region 21 and close to the ground pattern 22 as much as possible.

In the above-mentioned antenna device 100, a current supplied from the feed line 26 to the antenna block 10 flows finally in the ground pattern 22 through the first pad electrode 13, the first side surface conductor 16, the upper surface conductor 12, the second side surface conductor 17, and the second pad electrode 14. Part of the current supplied to the antenna block 10 flows immediately in the ground pattern 22 through the impedance adjusting pattern 27. As described above, the first pad electrode 13 is connected to the ground pattern 22 through the impedance adjusting pattern 27, and the radiation conductor is short-circuited near the feed point. Therefore, the antenna device 100 has the configuration as the inverted F antenna. A given electric field is also generated by the passage of the current through the antenna device 100, and the whole antenna block including the conductive pattern on the mounting board 20 acts as the antenna.

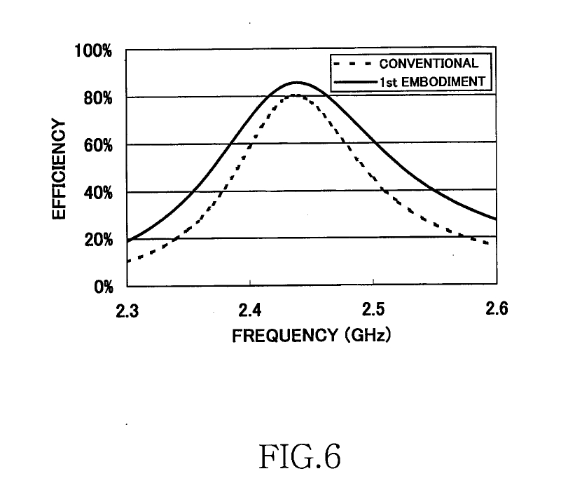

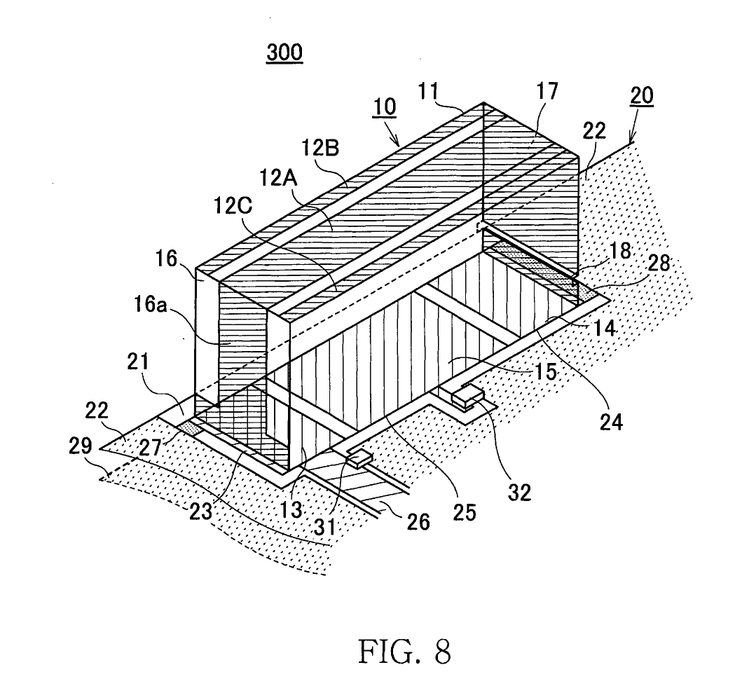

FIG. 6 is a graph showing comparison a characteristic of the antenna device 100 of the first embodiment and a characteristic of the conventional antenna device (see FIG. 8). In FIG. 6, a horizontal axis indicates a frequency and a vertical axis indicates antenna efficiency.

As shown in FIG. 6, the antenna efficiency of the antenna device 100 of the first embodiment is better than that of the conventional antenna device in a measured frequency range. Both the antennae have the center frequency of about 2.4 GHz. At the center frequency, the antenna device 100 has the antenna efficiency of about 85%, and the conventional antenna device has the antenna efficiency of about 80%.

As described above, in the structure of the antenna device 100 of this embodiment, the first impedance adjusting unit provided on the mounting board acts as the ground electrode of the inverted F antenna, and the antenna block does not includes the ground electrode, so that the variation in characteristic due to the misalignment of the ground electrode screen-printed in the antenna block can be prevented. Because the gap is formed in the leading end portion of the radial electrode to adjust the capacitance of the leading end portion, not only the resonant frequency can be adjusted, but also the large wavelength shortening effect is obtained. Therefore, the radiation conductor can be formed by a linear pattern without folding the radiation conductor, and the compact, high-frequency antenna can be realized.

In the antenna device 100 of this embodiment, the resonant frequency and the impedance are adjusted using the conductive pattern and chip reactor on the mounting board side, so that the resonant frequency can be adjusted without changing the antenna structure.

In the antenna device 100 of this embodiment, it is not necessary to form the conductive patterns in the third and fourth side surfaces 11E and 11F parallel to the longitudinal direction of the base 11. Therefore, the number of factors that reduces a production yield is decreased, the production process is shortened, and the relatively inexpensive direct feed type inverted F chip antenna can be provided.

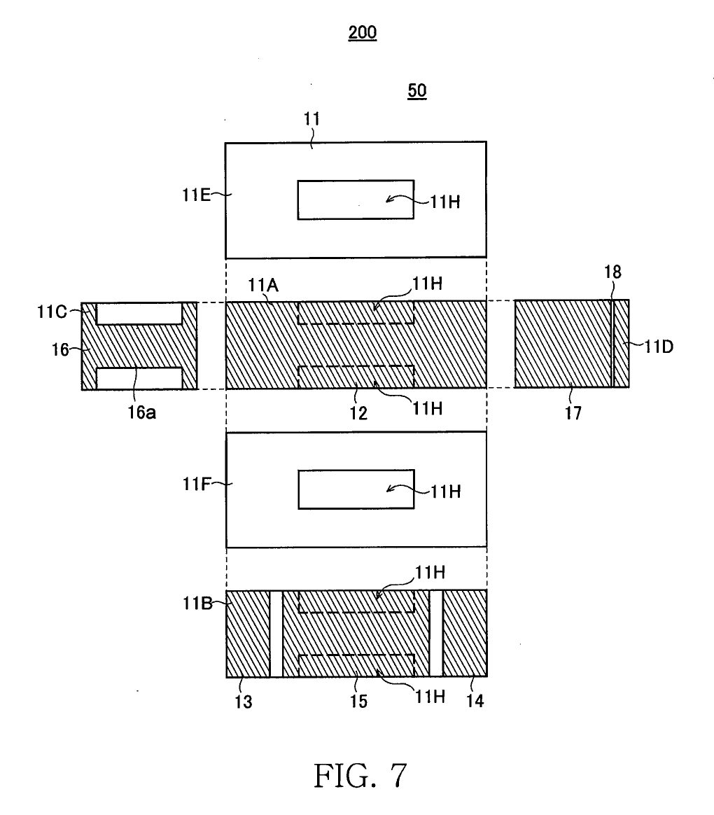

FIG. 7 is a development diagram showing a configuration of an antenna block 50 of an antenna device 200 according to a second embodiment of the present invention.

As shown in FIG. 7, the antenna device 200 of this embodiment includes the antenna block 50, and the antenna device 200 has the feature that holes 11H are made in the third and fourth side surfaces 11E and 11F of the base 11 constituting the antenna block 50. Because the conductive pattern is not formed on the side surface of the base 11, the holes 11H is made to achieve weight saving of the base 11. There is no particular limitation to the depth or the number of holes 11H. Each hole 11H do not pierce in FIG. 7, but the hole 11H may be made as a through-hole. In the antenna device 200 of the second embodiment, the weight saving of the whole antenna device 200 can be achieved in addition to the effect of the first embodiment. The high efficiency can be achieved because the effective permittivity of the base 11 is decreased. Additionally, the characteristic can be adjusted in association with the shape of the side surface conductor, and a degree of freedom of the design can be enhanced.

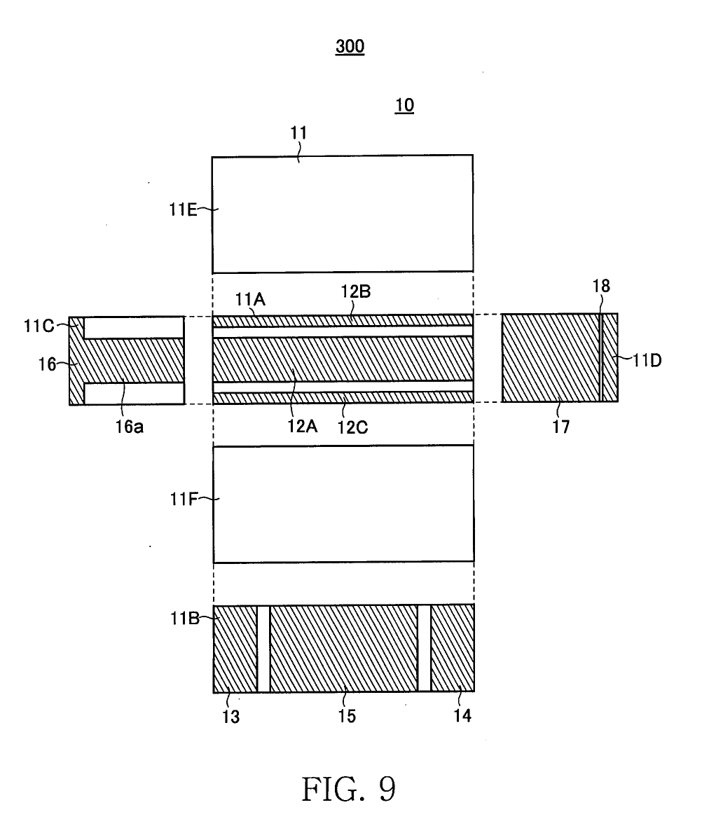

FIG. 8 is a schematic perspective view showing a configuration of an antenna block according to a third embodiment of the present invention. FIG. 9 is a development diagram of the antenna device of FIG. 8.

As shown in FIGS. 8 and 9, a antenna device 300 of this embodiment has the feature that first to third upper surface conductors 12A to 12C are provided in the upper surface of the base 11 constituting the antenna block 10.

The first upper surface conductor 12A is a band-like conductive pattern that is provided in the center of a width direction of the upper surface 11A of the base 11, and is extended across the total length in the longitudinal direction of the base 11. One end in the longitudinal direction of the first upper surface conductor 12A is connected to the first pad electrode 13 through the first side surface conductor 16. The other end in the longitudinal direction of the first upper surface conductor 12A is connected to the second pad electrode 14 through the second side surface conductor 17.

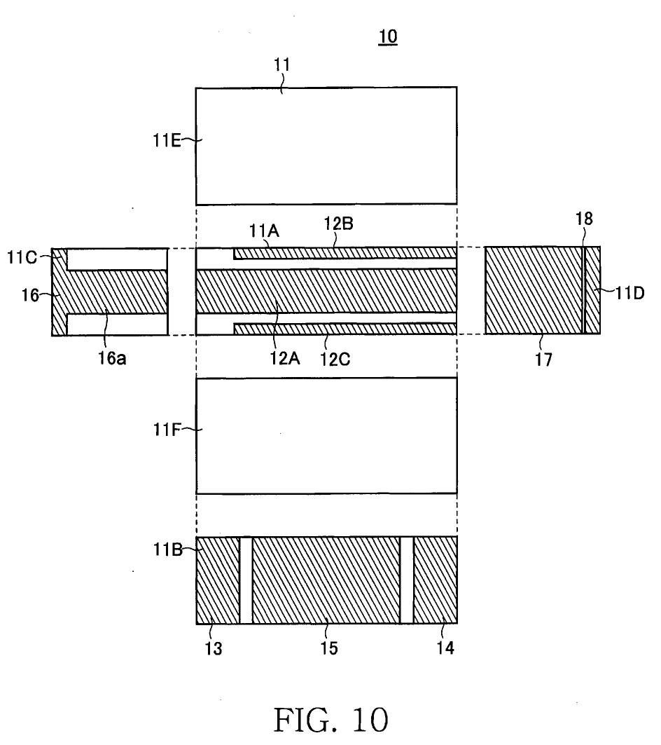

The second and third upper surface conductors 12B and 12C are band-like conductive patterns that are provided in the upper surface 11A of the base 11 along with the first upper surface conductor 11A, and are provided on both sides of the first upper surface conductor 12A. The second and third upper surface conductors 12B and 12C are provided in parallel with the second upper surface conductor 11A along an edge of the upper surface 11A of the base 11. The widths of the second and third upper surface conductors 12B and 12C are set narrower than that of the first upper surface conductor 11A and preferably set about 0.3 to about 0.6 time the width of the first upper surface conductor 12A. In the third embodiment, the second and third upper surface conductors 12B and 12C are extended across the total length in the longitudinal direction of the base 11. Alternatively, as shown in FIG. 10, the second and third upper surface conductors 12B and 12C may partially be formed in the longitudinal direction of the base 11. That is, the total lengths of the second and third upper surface conductors 12B and 12C maybe shorter than that of the first upper surface conductor 12A.

One end of each of the second and third upper surface conductors 12B and 12C is connected to the second side surface conductor 17, and the other end constitutes an open end. Therefore, the other end of the first upper surface conductor 11A is connected to one end of each of the second and third upper surface conductors 12B and 12C through the second side surface conductor 17 including the gap 18. The first upper surface conductor 12A is folded in the second side surface conductor 17 and connected to the second upper surface conductor 12B, and is also folded in the second side surface conductor 17 and connected to the third upper surface conductor 12C, thereby forming the radiation conductor having the folded structure. Accordingly, even if the base 11 itself is miniaturized, the desired electric length can be secured to realize the antenna having the low resonant frequency.

The first side surface conductor 16 has the constriction 16a whose width is narrower than that of the first side surface 11C, the width of the constriction 16a is set equal to that of the upper surface conductor 21A, and the constriction 16a is directly connected to one end of the first upper surface conductor 12A. That is, the first side surface conductor 16 does not include a portion whose width is equal to that of the first side surface 11C in the upper end portion of the first side surface 11C. In the first embodiment, because the upper surface conductor 12 is formed in the whole of the width direction of the upper surface 11A of the base 11, preferably the first side surface conductor 16 has the width equal to that of the upper surface conductor 12 in the upper end portion of the first side surface 11C. On the other hand, in the third embodiment, the width of the first upper surface conductor 12A is narrower than that of the upper surface 11A of the base 11, and it is necessary that the other end of each of the second and third upper surface conductors 12B and 12C constitute the open end. Therefore, in the third embodiment, the width of the first side surface conductor 16 is set narrower than that of the first side surface 11C in the upper end portion of the first side surface 11C.

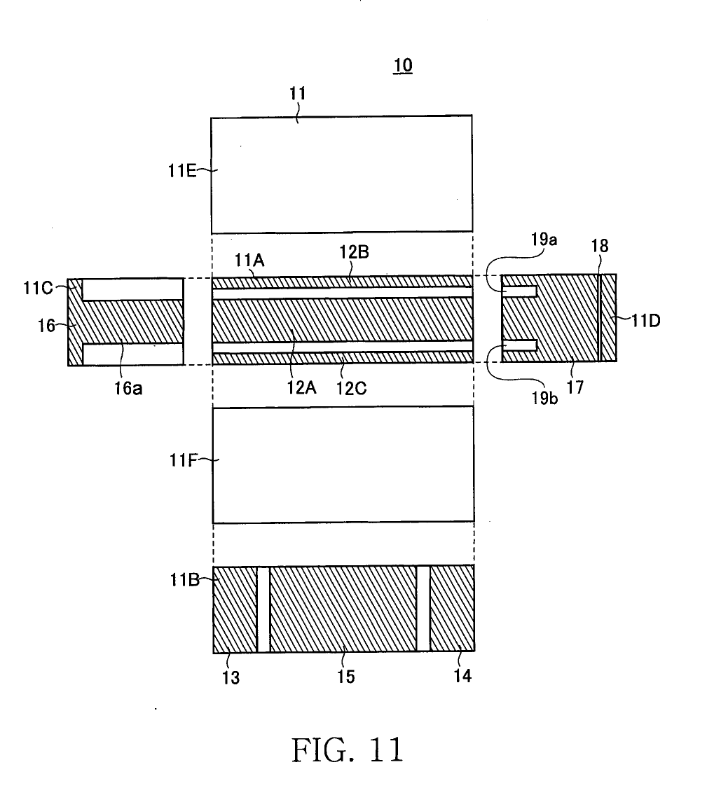

In the third embodiment, the other end of the first upper surface conductor 11A and one end of each of the second and third upper surface conductors 12B and 12C are connected as the shortest distance through the second side surface conductor 17. Alternatively, as shown in FIG. 11, a distance between the other end of the first upper surface conductor 11A and one end of each of the second and third upper surface conductors 12B and 12C may be increased by providing slits 19a and 19b in the second side surface conductor 17. At this point, it can be considered that, in the slit 19a, a slit that divides the first upper surface conductor 11A and the second upper surface conductor 12B is directly extended to the second side surface 11D, and it can be considered that, in the slit 19b, a slit that divides the first upper surface conductor 11A and the third upper surface conductor 12C is directly extended to the second side surface 11D. Therefore, the antenna having the lower resonant frequency can be realized.

As described above, the antenna device 300 of the third embodiment includes the first upper surface conductor 12A that is of the main radiation conductor provided in the center of the width direction of the upper surface 11A of the base 11 and the second and third upper surface conductors 12B and 12C that are of the sub radiation conductors provided on both sides thereof. Additionally, the power feeding is directly performed to one end of the first upper surface conductor 12A, and the second side surface conductor 17 that is of a capacitance bearing electrode is interposed in the folded position between the first upper surface conductor 12A and the second and third upper surface conductors 12B and 12C. Therefore, the stable antenna characteristic can be obtained irrespective of the position on the mounting board. The radiation conductor formed on the upper surface 11A of the base 11 has the folded structure, so that a good radiation characteristic can be obtained at the resonant frequency that is lower than that of the antenna device 100 of the first embodiment including the radial conductive pattern with no folding. The more compact antenna can be formed when the resonant frequency is kept constant.

In the embodiment, the three band-like conductive patterns is formed by providing the second and third upper surface conductors 12B and 12C on both sides of the first upper surface conductor 12A. There is no particular limitation to the number of upper surface conductors. For example, only the second upper surface conductor 12B or only the third upper surface conductor 12C may be provided on one side of the first upper surface conductor 12A to form two band-like conductive patterns. However, when the second and third upper surface conductors 12B and 12C are provided on both sides of the first upper surface conductor 12A, a symmetrical pattern layout is obtained, which facilitates the antenna design to reduce mounting constraints. Further, in the invention, each two band-like conductive patterns are provided on both sides of the central band-like conductive pattern to form a total of five band-like conductive patterns.

Although the embodiments of the present invention are described above, the invention is not limited to the embodiments. Various modifications can be made without departing from the scope of the present invention, and obviously the modifications are included in the scope of the present invention.

In the antenna devices of the embodiments, the base 11 has the rectangular parallelepiped shape. However, it is not always necessary that the base 11 have the strictly rectangular parallelepiped shape. For example, a taper may be provided in the corner portion of the rectangular parallelepiped in order to specify the orientation of the base 11.

In the embodiments, the dielectric material is used as the material for the base 11. Alternatively, a magnetic material having a dielectric characteristic may be used instead of the dielectric material. In such cases, because the wavelength shortening effect of 1/{(ε×μ)^{1/2}} is obtained, the large wavelength shortening effect can be obtained using the magnetic material having the high permeability μ. Because electrode impedance is determined by μ/ε, the impedance can be enhanced using the magnetic material having the high permeability μ. Therefore, excessively high Q of the antenna can be decreased to obtain a broadband characteristic.

In the embodiments, the conductive paste is directly screen-printed on the base 11 in which the trench 11T is formed, thereby forming the second side surface conductor 17. Alternatively, the conductive paste may be screen-printed after the trench 11T is filled with resin. When the resin is removed after the screen printing, the unnecessary conductive paste is removed together, which allows the conductive paste to be prevented from invading in the trench 11T. Accordingly, the working accuracy of the gap 18 can further be enhanced.

In the embodiments, the linear gap which is parallel to the upper and lower surfaces of the base 11 is used. Alternatively, for example, the linear gap may be inclined with respect to the upper and lower surfaces of the base 11, or a meandering gap may be provided.

In the embodiments, the I-shape conductive pattern is formed on the first side surface 11C of the base 11. In the invention, the conductive pattern is not limited to the I-shape. For example, another shape such as a T-shape having a portion whose width is narrower than that of the first side surface 11C maybe used. The conductive pattern maybe formed on the whole of the first side surface. The position in which the I-shape pattern is formed is not limited to the first side surface 11C, but the position may be located in the upper surface 11A of the base 11.

In the embodiments, the conductive pattern is used as the first impedance adjusting unit while the chip reactor is used as the second impedance adjusting unit. The invention is not limited to the configuration, but both the first and second impedance adjusting units may be formed as the conductive pattern, or may be formed as the chip reactor. However, when the conductive pattern is used as the first impedance adjusting unit, the conductive pattern can be formed along with other conductive patterns on the board. When the chip component is used as the second impedance adjusting unit, a component beyond the adjustment of the first impedance adjusting unit can be performed the adjustment with high accuracy. The same holds true for the frequency adjusting unit.

What is claimed is:

1. An antenna device comprising:
an antenna block; and
a mounting board on which the antenna block is mounted, wherein
the antenna block includes:
abase that is made of a dielectric material or a magnetic material and has substantially rectangular parallelepiped shape;
an upper surface conductor that is formed on an upper surface of the base;
first and second pad electrodes that are formed in end portions in a longitudinal direction of a bottom surface of the base;
a first side surface conductor that is formed on a first side surface of the base to directly connect the upper surface conductor and the first pad electrode; and
a second side surface conductor that is formed on a second side surface of the base and includes a gap having a predetermined width, the second side surface conductor connecting the upper surface conductor and the second pad electrode through the gap, and
the mounting board includes:
an antenna block mounting region that is provided in one of principal surfaces;
first and second land patterns that are provided in the mounting region corresponding to positions of the first and second pad electrodes, respectively;
a first ground pattern that is provided around the mounting region;
a feed line that is connected to the first land pattern; and
a first impedance adjusting unit that connects the first land pattern and the first ground pattern.

2. The antenna device as claimed in claim 1, wherein the mounting board further includes a second ground pattern that is provided below the mounting region.

3. The antenna device as claimed in claim 1 further comprising a second impedance adjusting unit that connects the feed line and the first ground pattern.

4. The antenna device as claimed in claim 1 further comprising a first frequency adjusting unit that connects the second land pattern and the first ground pattern.

5. The antenna device as claimed in claim 1, wherein the antenna block further includes a third pad electrode that is formed in a central portion in a longitudinal direction of the bottom surface of the base, and the mounting board further includes a third land pattern that is provided in the mounting region corresponding to the position of the third pad electrode.

6. The antenna device as claimed in claim 5 further comprising a second frequency adjusting unit that is provided on the mounting board to connect the third land pattern and the first ground pattern.

7. The antenna device as claimed in claim 1, wherein a trench is provided in a position where the gap is formed on the second side surface of the base.

8. The antenna device as claimed in claim 7, wherein a sectional shape of the trench is a substantially U-shape.

9. The antenna device as claimed in claim 1, wherein the first side surface conductor has a constriction whose width is narrower than that of the base.

10. The antenna device as claimed in claim 1, wherein a hole is formed on third and fourth side surfaces of the base, the third and fourth side surfaces being different from the first and second side surfaces.

11. The antenna device as claimed in claim 1, wherein the upper surface conductor includes:
a first upper surface conductor that is provided in the center of a width direction of the upper surface of the base; and
a second upper surface conductor that is provided in parallel with the first upper surface conductor on at least one side of the first upper surface conductor, and
one end of the first upper surface conductor is connected to one end of the second upper surface conductor through the second side surface conductor, and
the other end of the second upper surface conductor is opened.

12. The antenna device as claimed in claim 1, wherein the upper surface conductor includes:
the first upper surface conductor that is provided in the center of the width direction of the upper surface of the base; and
second and third upper surface conductors that are provided in parallel with the first upper surface conductor on both sides of the first upper surface conductor, and
one end of the first upper surface conductor is connected to one end of each of the second and third upper surface conductors through the second side surface conductor, and
the other end of each of the second and third upper surface conductors is opened.

13. A wireless communication equipment including the antenna device as claimed in claim 1.
